(19) United States
(12) Patent Application Publication
(10) Pub. No.: US 2009/0304114 A1
(43) Pub. Date: Dec. 10, 2009

(54) METHOD FOR DECODING DIGITAL INFORMATION ENCODED WITH A CHANNEL CODE

(75) Inventor: Andreas Burg, Maur (CH)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: ETH ZÜRICH, Zurich (CH)

(21) Appl. No.: 12/282,615

(22) PCT Filed: Mar. 5, 2007
(86) PCT No.: PCT/CH2007/000116

§ 371 Date: Jan. 12, 2009

Related U.S. Application Data
(60) Provisional application No. 60/783,229, filed on Mar. 16, 2006.

(51) Int. Cl. H04L 1/00; H04L 27/06

(52) U.S. Cl. 375/340

(57) ABSTRACT

The performance of multiple-input multiple-output (MIMO) systems, employing coding with multiple antennas depends heavily on the demapper algorithm which is used for MIMO detection. Soft-output demappers lead to better bit error rate (BER) performance compared to hard-decision demappers, but have a higher implementation complexity. The algorithm, proposed in this paper, relies on low-complexity harddecision MIMO detection. The reliability information for the received bits used to compute log-likelihood ratios is based on an estimate of the average bit error rate which is for example derived from the corresponding channel state information only. The algorithm is applicable to any hard-decision MIMO detector. As an example, we describe the application of the scheme to a linear MMSE detector and to sphere decoding with early termination.

### CROSS REFERENCE TO RELATED APPLICATIONS

This application claims the priority of U.S. provisional patent application 60/783,229, filed Mar. 16, 2006, the disclosure of which is incorporated herein by reference in its entirety.

### TECHNICAL FIELD

The invention relates to a method for decoding digital information encoded with a channel code having redundancy as well as to a device for carrying out this method.

### BACKGROUND ART

The combination of multiple-input multiple-output (MIMO) systems, with orthogonal frequency division multiplexing (OFDM) and channel coding, for example based on bit interleaved coded modulation (BICM) [1] has recently attracted significant attention. MIMO offers high spectral efficiency through spatial multiplexing, OFDM provides resilience against interference from multipath propagation and channel coding can be used to efficiently exploit the diversity in a frequency-selective wideband MIMO channel.

The block diagrams of a generic MIMO-BICM transmitter and receiver are shown in FIG. 1. The transmitter uses a channel code having redundancy to protect the data bits. The outputs of the corresponding channel encoder and of a potential subsequent interleaver are the original encoded data bits prior to mapping and transmission (bₘ⁽ⁱ⁾). These bₘ⁽ⁱ⁾ are modulated (mapped) and transmitted. The receiver consists of a demapper and of a channel decoder (i.e., a decoder (e.g., Viterbi decoder) for a channel code), linked by a de-interleaver (II⁻¹). The channel decoder delivers corrected data bits, by using the properties of the channel code and the redundancy added by the channel code. The task of the demapper is to undo the combined effects of the modulation and the channel and to format the received data in such a way that it can be processed by the channel decoder. Ideally, the demapping should not entail any loss of information. The challenge is in the design of MIMO demappers that provide good performance with a low implementation complexity. The trade-offs are thereby in the demapper algorithms itself and in the output they provide to the decoder. Hard-decision demappers providing binary decisions allow for the application of advanced receiver algorithms such as sphere decoding with a still low hardware complexity [2] but entail a significant loss of information due to the quantized information at their output. For soft-output decoding one has to resort to suboptimal MIMO demapper algorithms to keep silicon complexity low [3-5]. However, the presented implementations often still entail a significant complexity, part of which is in the memory requirements of the interleaver, which needs to store the soft-outputs (multiple bits) for each transmitted bit.

### DISCLOSURE OF THE INVENTION

The present invention relates to a low-complexity algorithm to compute soft-outputs in (MIMO) communication systems with BICM. One of the main advantages of the described method is that it allows to compute soft-information without using complex soft-output demappers. Instead, low-complexity hard-decision MIMO demappers can be employed and approximate soft-information can be derived from average bit error rates conditioned for example on channel state information (CSI). The result is a reduction of the demapper complexity and a significant memory reduction in the interleaver. The general idea is applicable to different single-input single-output (SISO) and MIMO demapper algorithms. As examples, we demonstrate the application to MIMO MMSE detection and we show how the same technique can be employed to mitigate the performance loss associated with MIMO sphere decoding with early, termination [6].

Now, in order to implement these and still further objects of the invention, the invention relates to a method for decoding digital information encoded with a channel code having redundancy, said method comprising the steps of
1. feeding received data to a hard-decision demapper making binary decisions for generating a sequence of demapped data bits.
2. providing reliability information indicative of the reliability of each bit of the demapped data bits.
3. generating corrected data from the demapped data bits from the reliability information and from a redundancy in said channel code.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 shows a generic MIMO-BICM receiver (prior art),

FIG. 2 shows a MIMO-BICM receiver with hard-output demapper and CSI based bit metrics,

FIG. 3 shows Simulation results for M_{T}=M_{R}=4 with QPSK, 16-QAM and 64-QAM modulation and MMSE detection using hard- and soft-decision outputs and CSI-based log-likelihood ratios,

FIG. 4 shows the block diagram of early terminated SD with soft-output,

FIG. 5 shows the BER performance for a rate 1/2 coded 4×4 system with 16-QAM modulation.

### MODES FOR CARRYING OUT THE INVENTION

### 1 Outline

In the next section, we briefly describe the reference system model that we use for our explanations. In Section we present our new approach to compute approximate soft-information and in Sec. we apply the scheme to MMSE detection and illustrate the bit error rate (BER) performance by means of simulations. Sec. applies the presented method to sphere decoding with early termination. Conclusions are given in Sec. and the concept of the invention is analyzed in Sec.

### 2 Reference System

2.1 System Model

For clarity of exposition a fast-fading narrowband system with M_{T} transmit and M_{R} receive antennas is discussed in which the MIMO channel H[t] changes independently from one symbol to the next. This model replaces for example a wideband MIMO-OFDM system with a frequency selective channel and with proper interleaving in the frequency domain [7].

In the transmitter, the binary data stream b[t] is first encoded using a channel code having redundancy. The bits are then interleaved and the original encoded data bits prior to mapping and transmission are demultiplexed to M_{T} modulators, each of which maps q bits to a constellation point according to a Gray coded modulation scheme. The outputs of the modulators form the transmitted vector s[t], which is normalized such that ξ{∥s[t]∥²}=1. The usable rate of the system is R=qM_{T}.

The MIMO channel is described by the M_{R}×M_{T} dimensional matrix H[t] whose entries are assumed i.i.d. Gaussian distributed across time and space with zero mean and variance one. The received signal vector y[t] at the receive antennas is given by

y[t]=H[t]s[t]+n[t], (1)

where the M_{R} dimensional vector n[t] represents the i.i.d. proper complex Gaussian noise with variance σ² per complex dimension. The signal to noise ratio (SNR) per receive antenna is defined as SNR=1/σ².

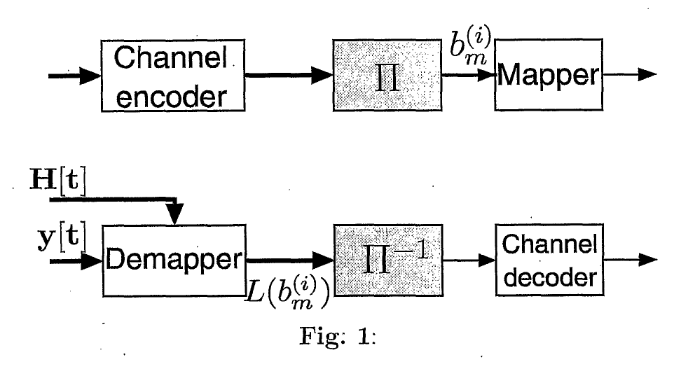

As in the generic diagram in FIG. 1, the MIMO-BICM receiver consists of a MIMO detector as demapper and a soft-input/hard-output channel decoder, connected by a de-interleaver. In the following, we omit the time index [t] for brevity, writing y instead of y[t] and so on.

2.2 Soft-Output Demapper

The task of the demapper is to separate the received vector y into pieces of information that correspond as uniquely as possible to the individual original encoded data bits prior to mapping and transmission that were mapped to the corresponding transmitted vector s. An appropriate input-metric for the subsequent channel decoder for the ith bit in the mth spatial stream is given by

$${Z}_{m}^{( i )} ( 𝒯 ) = \frac{P ( {b}_{m}^{( i )} = + 1 \vert y , H , {σ}^{2} )}{P ( {b}_{m}^{( i )} = - 1 \vert y , H , {σ}^{2} )} \qquad ( 2 )$$

which is advantageously expressed as log-likelihood ratio given by

$$L ( {b}_{m}^{( i )} ) = log ( \frac{P ( {b}_{m}^{( i )} = + 1 \vert y , H , {σ}^{2} )}{P ( {b}_{m}^{( i )} = - 1 \vert y , H , {σ}^{2} )} ) , \qquad ( 3 )$$

assuming no a-priori knowledge about the transmitted bits (P(bₘ⁽ⁱ⁾=1)=P(bₘ⁽ⁱ⁾=−1)=1/2). With an exhaustive search detector, L(bₘ⁽ⁱ⁾) can be calculated as

$$\begin{matrix}L ( {b}_{m}^{( i )} ) = log ( \frac{{\sum }_{\hat{s} ∈ {O}_{i , m , + 1}^{{M}_{T}}} {e}^{- \frac{{‖ y - H \hat{s} ‖}^{2}}{{σ}^{2}}}}{{\sum }_{\hat{s} ∈ {O}_{i , m , - 1}^{{M}_{T}}} {e}^{- \frac{{‖ y - H \hat{s} ‖}^{2}}{{σ}^{2}}}} ) & ( 4 ) \\ \approx \frac{1}{{σ}^{2}} ( {min}_{\hat{s} ∈ {O}_{i , m , + 1}^{{M}_{T}}} {‖ y - H \hat{s} ‖}^{2} - {min}_{\hat{s} ∈ {O}_{i , m , - 1}^{{M}_{T}}} {‖ y - H \hat{s} ‖}^{2} ) , & ( 5 )\end{matrix}$$

where O_{i,m,+1}^{M}^{_{T}} and O_{i,m,-1}^{M}^{_{T}} denote the subsets of vector symbols for which the ith bit in the mth stream is zero or one, respectively. Unfortunately, the complexity of considering all possible candidate vector symbols grows exponentially with the rate R so that detector implementations for high rates (R>8) are currently not feasible and not economic, even with the max-log approximation in (5).

### 3 Reduced Complexity MIMO BICM System

In the following, we shall introduce a suboptimal scheme that has the potential to reduce the complexity of the demapper in MIMO-BICM systems. The basic idea is to use a hard-output demapper and to obtain the associated reliability information based on average error probabilities conditioned for example on the corresponding CSI.

3.3 Modified System Architecture

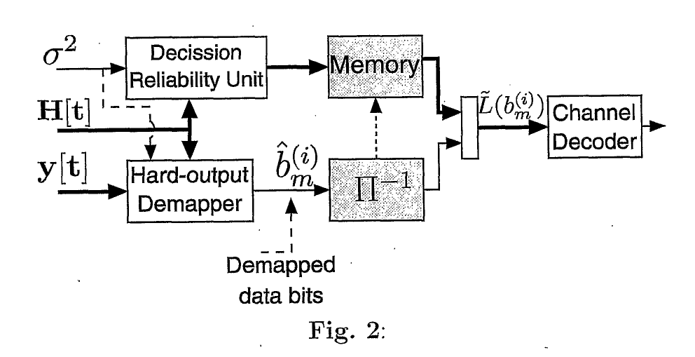

The block diagram of our modified MIMO-BICM receiver is shown in FIG. 2. A standard hard-output demapper makes binary hard-decisions on the received bits to obtain demapped data bits \hat{b}ₘ⁽ⁱ⁾, often represented as +1 or −1, instead of 0 or 1. An additional unit computes the average reliability of these hard-decisions, here based on H and σ², without knowledge of the received vector y. This information is combined with the hard-decisions to obtain approximate log-likelihood ratios (LLRs) \tilde{L}(bₘ⁽ⁱ⁾) for the channel decoder.

3.4 CSI Based LLR Computation

Using only knowledge of the hard-decisions \hat{b}ₘ⁽ⁱ⁾ and the channel H, approximate LLRs can be computed without knowledge of y according to

$$\tilde{L} ( {b}_{m}^{( i )} ) = log ( \frac{P ( {b}_{m}^{( i )} = + 1 \vert {\hat{b}}_{m}^{( i )} , H , {σ}^{2} )}{P ( {b}_{m}^{( i )} = - 1 \vert {\hat{b}}_{m}^{( i )} , H , {σ}^{2} )} ) . \qquad ( 6 )$$

Assuming that the demodulator has a symmetric error probability so that

$$\begin{matrix}P ( {b}_{m}^{( i )} \neq {\hat{b}}_{m}^{( i )} ) = P ( {b}_{m}^{( i )} \neq + 1 \vert {\hat{b}}_{m}^{( i )} = + 1 ) \\ = P ( {b}_{m}^{( i )} \neq - 1 \vert {\hat{b}}_{m}^{( i )} = - 1 ) ,\end{matrix} \qquad ( 7 )$$

one can write (6) as

$$\begin{matrix}\tilde{L} ( {b}_{m}^{( i )} ) = {\hat{b}}_{m}^{( i )} {R}_{m}^{( i )} ( H , {σ}^{2} ) \\ with & ( 8 ) \\ {R}_{m}^{( i )} ( H , {σ}^{2} ) = log ( {\tilde{Z}}_{m}^{( i )} ( H , {σ}^{2} ) ) \\ with & ( 9 ) \\ {\tilde{Z}}_{m}^{( i )} ( H , {σ}^{2} ) = \frac{1 - P ( {b}_{m}^{( i )} \neq {\hat{b}}_{m}^{( i )} \vert H , {σ}^{2} )}{P ( {b}_{m}^{( i )} \neq {\hat{b}}_{m}^{( i )} \vert H , {σ}^{2} )} , & ( 10 )\end{matrix}$$

because P(bₘ⁽ⁱ⁾=\hat{b}ₘ⁽ⁱ⁾)=1−P(bₘ⁽ⁱ⁾≠\hat{b}ₘ⁽ⁱ⁾).

Note that in (9) error probabilities are conditioned on H and σ². However the same method is applicable in the more general case in which the expected error probability P(bₘ⁽ⁱ⁾≠\hat{b}ₘ⁽ⁱ⁾|T) is conditioned on other side information summarized in the set T.

3.5 Impact on Complexity

The complexity savings that are associated with the proposed scheme depend on the employed demapper algorithm, on the side information, on the implementation of (7) and (9), and on numerous other system parameters such as the interleaver depth and the resolution of the LLRs. However, one can identify two points in a system, in which considerable complexity savings can be achieved:
A hard-decision demapper can be used instead of a potentially costly soft-output demapper. This is especially useful for advanced algorithms that already exhibit a significant complexity. For example, soft-sphere decoding [8] is known to have a much higher complexity compared to a hard-decision sphere decoder [2],
The memory storage in the inter leaver may be reduced significantly, as only the individual bits need to be interleaved, instead of the corresponding soft-information. The latter is stored in a separate memory, which is much smaller compared to the memory in the interleaver, as in general multiple bits share the same approximate soft-information.

### 4 Application to MIMO-BICM with MMSE Detection

In the following, we shall apply the scheme, presented in Section, to straightforward linear MMSE detection. The corresponding hard-decision demapper first computes

ŷ=GH^{H}y with G=(H^{H}H+M_{T}σ²I)⁻¹ (11)

and obtains \hat{b}ₘ⁽ⁱ⁾ through quantization of ŷₘ/W_{m,m} to the nearest constellation point, where yₘ is the mth entry of the vector y and W_{m,m} is the mth diagonal entry of the matrix W=GH^{H}H. 4.6 CSI Based LLR Computation for MMSE

For the computation of approximate LLRs, we first note that with linear MMSE detection each stream (m=1 . . . M_{T}) may exhibit a different error probability, while with Gray labeling it is reasonable to assume that all bits in one stream (i=1 . . . q) have a similar detection reliability. Hence, Rₘ⁽ⁱ⁾(H, σ²)≈Rₘ(H, σ²).

In order to obtain Rₘ(H, σ²), we start by computing the detection error probability of the individual symbols, conditioned on the corresponding channel H. To this end, we first determine the effective noise variance \tilde{σ}ₘ² of the mth stream after MMSE equalization [9] as follows

$${\tilde{σ}}_{m}^{2} = \frac{{G}_{m , m} {M}_{T} {σ}^{2}}{1 - {G}_{m , m} {M}_{T} {σ}^{2}} , \qquad ( 12 )$$

where G_{m,m} is the mth diagonal entry of the matrix G. As the quantization to the constellation points that yields \hat{b}ₘ⁽ⁱ⁾ is performed independently for the M_{T} streams, we ignore the fact that the noise is correlated and we further assume (in accordance with [3] and [4]) that it is also Gaussian distributed. The effective channel between the transmitter and the outputs of the MMSE demodulator can now be modeled as a SISO additive white Gaussian noise channel with the noise variance given by \tilde{σ}ₘ². The corresponding uncoded BER is then readily obtained from [10] as

$$P ( {b}_{m}^{( i )} \neq {\hat{b}}_{m}^{( i )} \vert {\tilde{σ}}^{2} ) = \frac{2}{q} Q ( \sqrt{\frac{1}{2} \frac{3}{{2}^{q} - 1} \frac{1}{{\tilde{σ}}_{m}^{2}}} ) , \qquad ( 13 )$$

assuming only single-bit error events occur due to the use of Gray labeling. Substituting (13) into (9) then yields Rₘ and together with \hat{b}ₘ⁽ⁱ⁾ finally \tilde{L}(bₘ⁽ⁱ⁾) for the MMSE detector.

4.7 Simulation Results

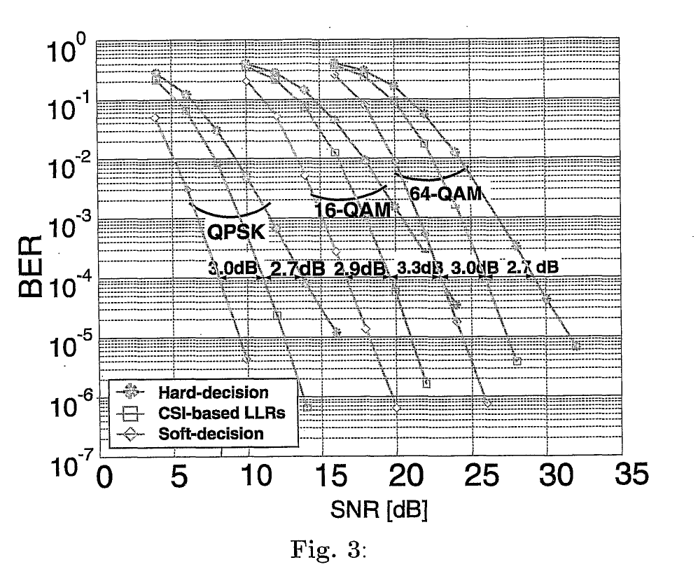

In order to assess the performance of the system, consider the simulation results presented in FIG. 3. The plot shows the rate 1/2 coded BER in a 4×4 spatial-multiplexing system with QPSK, 16-QAM and 64-QAM modulation. The employed convolutional code has a constraint length of 7 and is defined by the generator polynomials [133o, 171o]. Coding was performed across the spatial streams and across time and a traceback length of 55 was used in the Viterbi decoder. For QPSK, 16-QAM, and 64-QAM the blocklength was 512, 1024, and 1536 bits, respectively.

The reference simulations show BER results obtained with a hard-decision MMSE demodulator and BER results obtained with the soft-decision MMSE demodulator in [4]. For the latter, the soft-outputs were computed using the exact log-sum formulation, instead of the usual (suboptimal) max-log approximation.

As expected, the CSI-based detector performs in between the two reference cases. For a BER of 10⁻⁴, a SNR, gain of almost 3 dB is observed compared to the standard hard-decision MMSE detector. As the SNR increases, the gap between the hard-decision demodulator and the CSI-based demodulator widens, while the SNR penalty compared to the soft-decision MMSE detector remains approximately constant at 3 dB.

### 5 Application to Sphere Decoding with Early Termination

5.8 Sphere Decoding Algorithm

Sphere decoding (SD) starts by computing a unitary matrix Q and an upper triangular matrix U such that H=QU and considers ŷ=Q^{H}y. With this unitary transformation of the received vector the maximum likelihood detection problem for (1) corresponds to

$$\hat{s} = {arg min}_{s ∈ {O}^{{M}_{T}}} d ( s ) with d ( s ) = {‖ \hat{y} - Us ‖}^{2} , \qquad ( 14 )$$

where the distance d(s)=d₁(s) can be computed recursively according to

$$\begin{matrix}{d}_{i} ( {s}^{( i )} ) = {d}_{i + 1} ( {s}^{( i + 1 )} ) + {\vert {b}_{i + 1} - {U}_{ii} {s}_{i} \vert}^{2} & ( 15 ) \\ with {b}_{i + 1} = {\hat{y}}_{i} - {\sum }_{j = i + 1}^{{M}_{T}} {U}_{ij} {s}_{j} . & ( 16 )\end{matrix}$$

after initializing d_{M}_{_{T}}₊₁(s)=0. Since the partial Euclidean distances (PEDs) dᵢ(s⁽ⁱ⁾) depend only on s⁽ⁱ⁾=[sᵢ . . . s_{M}_{_{T}}]^{T} they can be associated with the nodes in a tree. Finding the ML solution corresponds to exhaustive tree traversal to identify the leaf with the smallest PED. The basic idea that leads to a complexity reduction compared to an exhaustive search is to restrict the search to only those sεO^{M}^{_{T}} for which Rs lies within a hypersphere of radius r around ŷ. To this end, the SD traverses the tree depth-first and prunes all nodes from the tree for which dᵢ(s⁽ⁱ⁾)>r². The children of a node are thereby examined in ascending order of their PEDs and the radius is updated according to r²←d(s) whenever a leaf is found.

Unfortunately, the variable runtime of the SD may not be tolerated by many applications. Early termination (ET) solves the problem simply by imposing a runtime constraint Dₘₐₓ on the recursive tree traversal procedure. When the decoding effort (determined by the number of visited nodes [2]) exceeds this constraint, the SD stops and returns the best solution it has found so far¹. Unfortunately, for symbols affected by ET, the output of the decoder does not necessarily correspond to the ML solution which degrades the BER performance. ¹Note that if the initial radius is set to r=∞, the SD always finds the nulling and canceling solution after M_{T} visited nodes.

5.9 Mitigation of Performance Loss from Early Termination

To mitigate the performance loss associated with ET using the method proposed in Sec., we subsume the relevant side information in the set T and employ the method described in Sec. The set T is comprised of the SNR, the runtime-limit Dₘₐₓ, and of a flag T which indicates whether the decoding process had to be terminated prematurely (T=1) or not (T=0).

S:{SNR,Dₘₐₓ,T} (17)

The conditional error probabilities required for the computation of

$${R}_{m}^{( i )} ( 𝒯 ) = log ( \frac{1 - P ( {b}_{m}^{( i )} \neq {\hat{b}}_{m}^{( i )} \vert 𝒯 )}{P ( {b}_{m}^{( i )} \neq {\hat{b}}_{m}^{( i )} \vert 𝒯 )} ) , \qquad ( 18 )$$

can be easily obtained by computer simulations. For T=0 (no early termination) P(bₘ⁽ⁱ⁾≠\hat{b}ₘ⁽ⁱ⁾|T) simply corresponds to the BER performance of the SD without runtime constraint. For T=1 only bits affected by ET after Dₘₐₓ visited nodes should ideally be taken into account. However, the average error probability (including those bits, not affected by ET) of a SD with ET after Dₘₐₓ visited nodes is a reasonable approximation to P(bₘ⁽ⁱ⁾≠\hat{b}ₘ⁽ⁱ⁾|T) with T=1 since the error performance is clearly dominated by those symbols affected by the runtime constraint. Once the conditional error probabilities are known, the reliability estimates Rₘ⁽ⁱ⁾(T) can be precomputed and can be stored in a small look-up table (LUT).

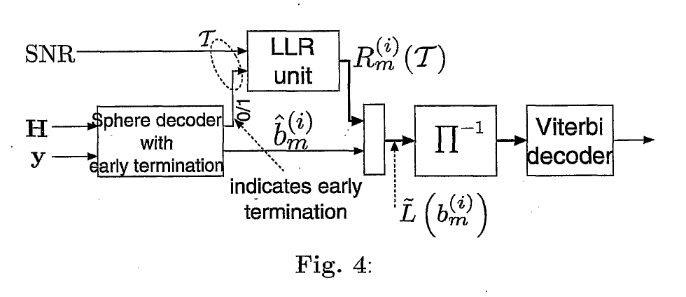

During decoding, this LUT is indexed by Dₘₐₓ, by the quantized signal to noise ratio and by the early termination indicator T as illustrated by the block diagram in FIG. 4. Rₘ⁽ⁱ⁾(T) is then combined with the tentative decision of the SD according to \tilde{L}(bₘ⁽ⁱ⁾)=\hat{b}ₘ⁽ⁱ⁾Rₘ⁽ⁱ⁾(T) and the resulting LLR estimate is passed on to the channel decoder via a deinterleaver (II⁻¹).

5.10 BER Simulation Results

For evaluating the BER performance improvement achieved by the described algorithm consider a coded MIMO-OFDM system with M_{R}=M_{T}=4 and 16-QAM modulation. The FFT-length is 64 and the cyclic prefix has a length of 16 samples. Forward error correction coding is performed with a rate 1/2 convolutional code with constraint length K=7 specified by the polynomial [133o,171o]. The length of a code block is defined by the number of bits in a single MIMO-OFDM symbol and the bits are interleaved randomly across tones and antennas. The frequency selective channel model used in the simulations follows the model “G” defined by the IEEE 802.11n taskgroup where we set an antenna spacing of one wavelength. At the receiver, perfect channel knowledge is assumed and a soft-input Viterbi decoder with a traceback length of 55 is employed for channel decoding.

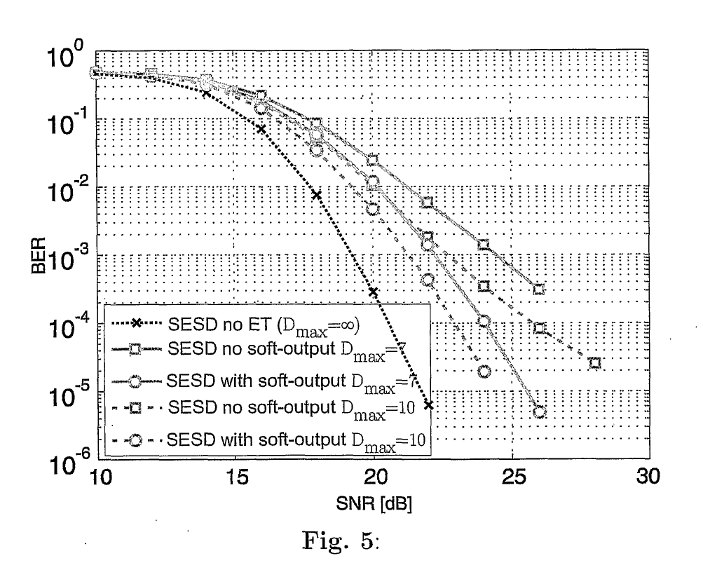

FIG. 5 shows the BER of SD with ET after Dₘₐₓ=7 and Dₘₐₓ=10 visited nodes, with and without soft-information. Clearly, the use of approximate reliability (i.e., soft) information leads to a considerable BER performance improvement compared to the case where only hard-decisions are forwarded to the channel decoder. It can also be observed that the corresponding SNR gap increases for better BER performance requirements and that the gain decreases as Dₘₐₓ increases.

### 6 Conclusions

We have shown how approximate log-likelihood ratios in a MIMO-BICM receiver can be derived from a combination of the binary output of any hard-decision demapper and from an estimate of the reliability of this hard-decision. We have also established a method to derive this reliability information from average bit error rates conditioned on various types of side information such as channel state information, the termination status or the runtime of an iterative decoder or the noise level affecting a particular received vector. In this document we have given two examples for the application of our algorithm: MMSE detection and sphere decoding with early termination. However, it is noted that the same method also applies to other MIMO and SISO algorithms. In particular, the same method can be applied to derive approximate log-likelihood ratios based on channel state information when using a hard-decision sphere decoder or in combination with a decision feedback (or successive interference cancellation) algorithm for MIMO detection or for transmission with inter-symbol interference.

The described method can also be applied to a subset of the demapped data bits, while a conventional method can be used to compute soft-information for the remaining data bits. Such an approach can be used where derivation of soft-information by conventional means is straightforward for some bits, but turns out to be difficult or complex for other demapped data bits. An example is list-sphere decoding, where soft-information is only available for some of the demapped data bits. The proposed method can then be applied to estimate the soft-information for the remaining demapped data bits.

While there are shown and described presently preferred embodiments of the invention, it is to be distinctly understood that the invention is not limited thereto but may be otherwise variously embodied and practiced within the scope of the claims.

### REFERENCES

[1] G. Caire, G. Taricco, and E. Biglieri, “Bit-interleaved coded modulation,” IEEE Trans. Inform. Theory, vol. 44, pp. 927-945, May 1998.
[2] A. Burg, M. Borgmann, M. Wenk, M. Zellweger, W. Fichtner, and H. Bölcskei, “VLSI implementation of MIMO detection using the sphere decoder algorithm,” IEEE J. Solid-State Circuits, vol. 40, no. 7, pp. 1566-1577, July 2005.
[3] M. R. G. Butler and I. N. Collings, “A zero-forcing approximate log-likelihood receiver for MIMO bit-interleaved coded modulation,” IEEE Commun. Lett., vol. 8, no. 2, pp. 105-107, February 2004.
[4] D. Seethaler, G. Matz, and F. Hlawatsch, “An efficient MMSE-based demodulator for MIMO bit-interleaved coded modulation,” in Proc. Globecom 2004, 2004, pp. 2455-2459.
[5] D. Garrett, L. Davis, S. ten Brink, B. Hochwald, and G. Knagge, “Silicon complexity for maximum likelihood MIMO detection using spherical decoding,” IEEE J. Solid-State Circuits, vol. 39, pp. 1544-1552, 2004.
[6] A. Burg, M. Borgmann, M. Wenk, G. Studer, and H. Bölcskei, “Advanced receiver algorithms for mimo wireless communications,” in Proc. ACM Design Automation and Test in Europe Conf., March 2006.
[7] S. H. Müller-Weinfurtner, “Coding approaches for multiple antenna transmission in fast fading and ofdm,” IEEE Trans. Signal Processing, vol. 50, no. 10, pp. 2442-2450, October 2002.
[8] B. M. Hochwald and S. ten Brink, “Achieving near-capacity on a multiple-antenna channel,” IEEE Trans. Commun., vol. 51, no. 3, pp. 389-399, March 2003.
[9] A. Paulraj, R. Nabar, and D. Gore, Introduction to Space-Time Wireless Communications. Cambridge Univ. Press, 2003.
[10] D. Tse and P. Viswanath, Fundamentals of Wireless Communication. Cambridge, UK: Cambridge Univ. Press, 2005.

1. A method for decoding digital information encoded with a channel code having redundancy, said method comprising the steps of:
I. feeding received data to a hard-decision demapper making binary decisions for generating a sequence of demapped data bits;
II. providing reliability information indicative of the reliability of each bit of the demapped data bits; and
III. generating corrected data from the demapped data bits from the reliability information and from a redundancy in said channel code.

2. The method of claim 1 wherein the received data is received through a multiple-input multiple-output system.

3. The method of claim 1 wherein the hard decision demapper used in step I is a hard-decision demapper for a multiple-input multiple-output system.

4. The method of claim 3 where the hard decision demapper is
a. a linear minimum mean squared error detector; or
b. a zero forcing detector; or
c. a sphere decoder; or
d. a k-best decoder; or
e. a maximum likelihood decoder; or
f. a device employing different demapper algorithms.

5. The method of claim 1 where step II comprises the calculation of
$$Z ( {b}_{m}^{( i )} ) = \frac{P ( {b}_{m}^{( i )} = + 1 \vert {\hat{b}}_{m}^{( i )} , T )}{P ( {b}_{m}^{( i )} = - 1 \vert {\hat{b}}_{m}^{( i )} , T )} . \qquad ( 19 )$$
wherein T is in formation describing the state of the transmission channel and/or the noise and/or the state of the hard-decision demapper used in step I and wherein \hat{b}ₘ⁽ⁱ⁾ are the demapped data bits, P(bₘ⁽ⁱ⁾|\hat{b}ₘ⁽ⁱ⁾, T) denotes the probability that an original encoded data bit bₘ⁽ⁱ⁾ prior to mapping and transmission was +1 or −1, corresponding to 0 or 1, respectively conditioned on \hat{b}ₘ⁽ⁱ⁾ and T.

6. The method of claim 5 where T comprises:
a. the channel H and/or the noise variance σ²; and/or
b. an estimate of the channel H and/or an estimate of the noise variance σ²; and/or
c. a runtime constraint for a recursive decoding algorithm and an indicator specifying for each received bit whether demapping had to be terminated prematurely due to a runtime constraint or not; and/or
d. the type of the demapper algorithm applied to a particular received bit.

7. The method of claim 1 where the demapper is a sphere decoder with early termination.

8. The method of claim 7 where T comprises an indicator specifying for each demapped data bit whether sphere decoding had to be terminated prematurely clue to a runtime constraint or not.

9. The method of claim 8 where the runtime constraint is variable and where T also contains the runtime constraint in effect for each bit output by the demapper.

10. The method of claim 1 where Z(bₘ⁽ⁱ⁾) is calculated from an estimate of the decision-error probability P(bₘ⁽ⁱ⁾≠\hat{b}ₘ⁽ⁱ⁾|T) of the hard-decision demapper according to
$${\tilde{Z}}_{m}^{( i )} ( T ) = \frac{1 - P ( {b}_{m}^{( i )} \neq {\hat{b}}_{m}^{( i )} \vert T )}{P ( {b}_{m}^{( i )} \neq {\hat{b}}_{m}^{( i )} \vert T )} \qquad ( 20 )$$

11. The method of claim 1 where the inputs to the channel decoder are log-likelihood ratios \tilde{L}(bₘ⁽ⁱ⁾) calculated from an estimate of the decision-error probability P(bₘ⁽ⁱ⁾≠\hat{b}ₘ⁽ⁱ⁾|T) of the hard-decision demapper according to
$$\begin{matrix}\tilde{L} ( {b}_{m}^{( i )} ) = {\hat{b}}_{m}^{( i )} {R}_{m}^{( i )} ( T ) \\ with & ( 21 ) \\ {R}_{m}^{( i )} ( T ) = log ( \frac{1 - P ( {b}_{m}^{( i )} \neq {\hat{b}}_{m}^{( i )} \vert T )}{P ( {b}_{m}^{( i )} \neq {\hat{b}}_{m}^{( i )} \vert T )} ) , & ( 22 )\end{matrix}$$
where \hat{b}ₘ^{(i)ε{-}1, +1} are the demapped data bits delivered by the hard-decision demapper for the corresponding original encoded data bits prior to mapping and transmission bₘ⁽ⁱ⁾.

12. The method of claim 1 when applied to only a subset of the transmitted and/or received bits.

13. A device comprising means for carrying out the method of claim 1.
